(19) United States
(12) Patent Application Publication
(10) Pub. No.: US 2006/0146006 A1
(43) Pub. Date: Jul. 6, 2006

(54) Liquid crystal display

(76) Inventors: Yong-Hui Lee, Gyeonggi-do (KR); Jin-Hee Park, Seoul (KR); Jeong-Hwan Shin, Gyeonggi-do (KR); Jae-Myong Yoo, Seoul (KR); Young Kim, Seoul (KR); Young-Joo Park, Gyeonggi-do (KR); Jin-Oh Kwan, Gyeonggi-do (KR)

Correspondence Address: David W. Heid;MacPHERSON KWOK CHEN & HEID LLP, Suite 226, 1762 Technology Drive, San Jose, CA, 95110, US

(21) Appl. No.: 11/323,774

(22) Filed: Dec. 29, 2005

(30) Foreign Application Priority Data
Jan. 4, 2005 (KR) 10-2005-0000411

(51) Int. Cl. G09G 3/36

(52) U.S. Cl. 345/102

(57) ABSTRACT

A liquid crystal display includes a first panel unit; a second panel unit; a first flexible printed circuit film (FPC) having an opening exposing the second panel unit; a light source unit providing the first and the second panel units and including a plurality of lamps; and a current controller controlling a current applied to the light source unit and including a capacitoritor is less than 100 nF.

### CROSS-REFERENCE TO RELATED APPLICATIONS

This application claims priority from Korean Patent Application No. 10-2005-0000411 filed on Jan. 4, 2005, the entire contents of which are hereby incorporated by reference.

### BACKGROUND

(a) Field of the Invention

The present invention relates to a liquid crystal display.

(b) Description of Related Art

Generally, a liquid crystal display (LCD) includes a liquid crystal (LC) panel unit. A LC panel unit typically includes two panels provided with pixel electrodes and common electrodes, and an LC layer with dielectric anisotropy interposed between the panels. The pixel electrodes are arranged in a matrix and are connected to switching elements such as thin film transistors (TFT) that sequentially apply data voltages to each row of the matrix. The common electrodes cover the entire surface of the upper panel and are supplied with a common voltage. A pixel electrode, a common electrode, and the LC layer can be electrically characterized as an LC capacitor, and the LC capacitor together with a switching unit forms the basic unit of a pixel.

The LCD displays images by applying an electric field to a liquid crystal layer situated between the two panels and regulating the strength of the electric field to adjust the transmittance of light passing through the liquid crystal layer. To prevent the LC layer from deteriorating due to the one-directional electric field, the polarity of the data voltage is reversed for each frame, for each row, or for each dot with respect to the common voltage. Alternatively, the polarities of the data voltage and the common voltage are reversed at the same time.

The LCD, as a small or medium sized display device, can be used as a so-called dual display device that has panel units on its inner and outer sides. Such dual-display LCD's are being vigorously researched and developed.

The dual display device includes a main panel unit mounted on the inside, a subsidiary panel unit mounted on the outside, a driving flexible printed circuit film (FPC) provided with signal lines to transmit input signals from external devices, an auxiliary FPC connecting the main panel unit to the subsidiary panel unit, and an integrated circuit or chip which controls the above-described elements.

The integrated circuit generates control signals and driving signals to control the main panel unit and the subsidiary panel unit. The integration chip is generally mounted as a COG (chip on glass). The driving FPC is also called an interface FPC because it connects an external device to the main panel unit.

While much effort has been invested in improving image quality for small and medium sized LCD's, efforts to reduce noise have not been successful. That is, generated noise has conventionally been tolerated as a trade-off for image quality.

### SUMMARY OF THE INVENTION

The present invention provides a liquid crystal display that has reduced noise.

A liquid crystal display according to an embodiment of the present invention includes: a first panel unit; a second panel unit; a first flexible printed circuit film (FPC) having an opening that exposes the second panel unit; a light source unit providing light the first and the second panel units and including a plurality of lamps; and a current controller that controls a current applied to the light source unit and including a capacitor having a capacitance less than 100 nF.

The current controller may also include: a current generator including a plurality of terminals and connected to one end of the lamp; and a current setting unit connected to the other end of the lamp and including the capacitor and a plurality of resistors.

The current controller may be located on the first FPC.

The liquid crystal display may further include: a second FPC attached to one side of the first panel unit; and a third FPC attached between the other side of the first panel unit and one side of the second panel unit.

The first and the second panel units may include a plurality of pixels each including a switching element and first and second display signal lines connected to the switching element.

The liquid crystal display may further include: a gate driver generating gate signals for application to the first display signal lines; and a data driver generating data voltages for application to the second display signal lines.

The liquid crystal display may further include a driving circuit chip driving the first and the second panel units.

The driving circuit chip may include the gate driver and the data driver.

The driving circuit chip may be mounted on the first panel unit.

The liquid crystal display according to another embodiment of the present invention includes: a first panel unit; a second panel unit; a first FPC having an opening exposing the second panel unit; and a common voltage generator that generates a common voltage for the first and the second panel units at a frequency exceeding 20 kHz.

The common voltage generator may include: an oscillator; and a voltage generator that generates a voltage in response to a signal from the oscillator.

The oscillator may include a resistor connected between a first terminal and a second terminal, having a resistance which is inversely proportional to the frequency of the common voltage.

The liquid crystal display may further include: a second FPC attached to one side of the first panel unit; and a third FPC attached between the other side of the first panel unit and one side of the second panel unit.

The first and the second panel units may include a plurality of pixels each including a switching element, and first and second display signal lines connected to the switching element.

The liquid crystal display may further include: a gate driver that generates gate signals for application to the first display signal lines; and a data driver that generates data voltages for application to the second display signal lines.

The liquid crystal display may further include a driving circuit chip that drives the first and the second panel units.

The driving circuit chip may include the common voltage generator, the gate driver, and the data driver.

The driving circuit chip may be mounted on the first panel unit.

The liquid crystal display according to still another embodiment of the present invention include: a first panel unit; a second panel unit; a first FPC having an opening exposing the second panel unit; and a second FPC attached to one side of the first panel unit; a third FPC attached between the other side of the first panel unit and one side of the second panel unit; and a backlight unit that provides light for the first and the second panel units, wherein the first and the second panel units are disposed opposite to each other, the backlight unit is interposed between the first and second panels, and an insulating member is interposed between the third FPC and the side of the backlight unit facing the second panel unit. The insulating member may be a double sided tape which is attached to both the backlight unit and the third FPC.

The first and the second panel units may include a plurality of pixels each including a switching element, and first and second display signal lines connected to the switching element.

The liquid crystal display may further include: a gate driver that generates gate signals for application to the first display signal lines; and a data driver that generates data voltages for application to the second display signal lines.

The liquid crystal display may further include a driving circuit chip which drives the first and the second panel units.

The driving circuit chip may include the gate driver and the data driver.

The driving circuit chip may be mounted on the first panel unit.

### BRIEF DESCRIPTION OF THE DRAWINGS

The present invention and preferred embodiments thereof are described in detail below by reference to the accompanying drawings wherein:

FIG. 1 is a block diagram of an LCD according to an embodiment of the present invention;

FIG. 2 illustrates a structure and an equivalent circuit diagram of a pixel of an LCD according to an embodiment of the present invention;

FIGS. 3A and 3B are schematic views of an LCD according to an embodiment of the present invention;

FIG. 4 is a schematic view of a circuitry unit comprising the driving FPC shown in FIG. 3B;

FIGS. 5A and 5B are tables illustrating experimental conditions under which the noise levels of an LCD according to an embodiment of the present invention were measured;

FIGS. 6A and 6B show how the noise levels depend on the capacitance of the capacitor shown in FIG. 4, for an LCD according to an embodiment of the present invention;

FIG. 7 is a block diagram of a common voltage generator according to another embodiment of the present invention; and

FIG. 8 is a schematic lateral side view of an LCD according to another embodiment of the present invention.

### DETAILED DESCRIPTION OF EMBODIMENTS

The present invention is described in detail hereinafter with reference to the accompanying drawings, in which preferred embodiments of the invention are shown. This invention may, however, be embodied in many different forms and should not be construed as limited to the embodiments set forth herein.

In the drawings, the thickness of the layers and regions are exaggerated for clarity. Like numerals refer to like elements throughout. When an element such as a layer, film, region, substrate, or panel is referred to as being “on” another element, it can be directly on the other element or intervening elements may also be present. In contrast, when an element is referred to as being “directly on” another element, there are no intervening elements present.

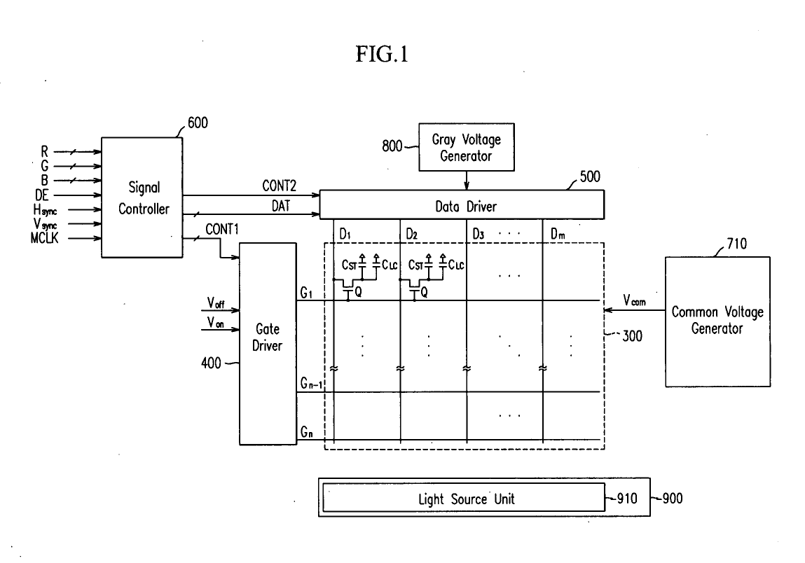

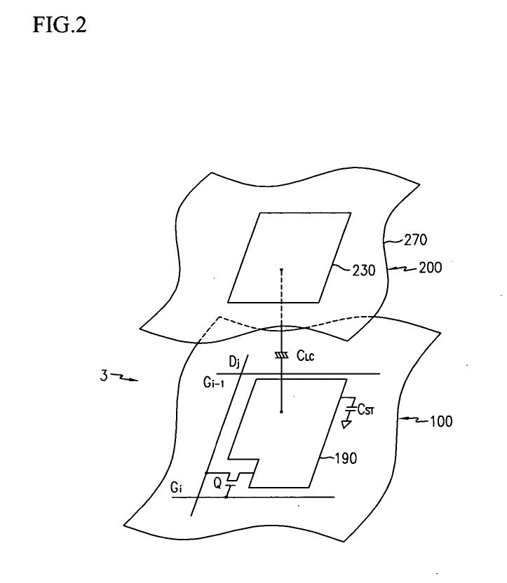

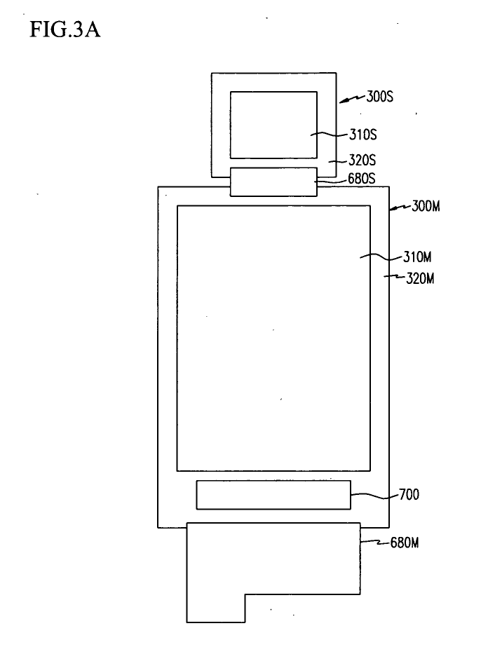

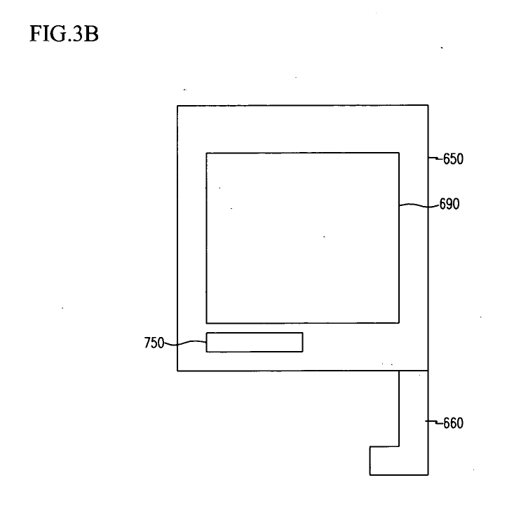

FIG. 1 is a block diagram of an LCD according to an embodiment of the present invention. FIG. 2 illustrates a structure and an equivalent circuit diagram of a pixel of an LCD according to an embodiment of the present invention. FIGS. 3A and 3B are schematic views of an LCD according to an embodiment of the present invention.

Referring to FIG. 1, an LCD according to an embodiment of the present invention includes an LC panel unit 300 and a common voltage generator 710 connected thereto, a gate driver 400 and a data driver 500, a gray voltage generator 800 connected to the data driver 500, a signal controller 600 controlling the above-described elements, and a backlight unit 900 providing light for the LC panel unit 300.

The LC panel unit 300, in the structural view shown in FIG. 2, includes a lower panel 100, an upper panel 200, and a liquid crystal (“LC”) layer 3 interposed therebetween. It also includes a plurality of display signal lines G1-Gn and D1-Dm and a plurality of pixels that are connected thereto and arranged substantially in a matrix as shown in the views in FIGS. 1 and 2.

The display signal lines G₁-Gₙ and D₁-Dₘ are provided on the lower panel 100, and include a plurality of gate lines G₁-Gₙ that transmit gate signals (called scanning signals) and a plurality of data lines D₁-Dₘ that transmit data signals. The gate lines G₁-Gₙ extend substantially in a row direction, and they are substantially parallel to each other. The data lines D₁-Dₘ extend substantially in a column direction, and they are also substantially parallel to each other.

Each pixel includes a switching element Q, which may be a thin-film transistor (TFT), connected to one of the gate signal lines G₁-Gₙ and one of the data signal lines D₁-Dₘ. An LC capacitor C_{LC} and a storage capacitor C_{ST} are connected to each switching element Q. The storage capacitor C_{ST} may be omitted if it is unnecessary.

Each switching element Q is provided on the lower panel 100 and has three terminals: a control terminal connected to one of the gate lines G1-Gn; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the lower panel 100, a common electrode 270 provided on the upper panel 200, and an LC layer 3 that acts as a dielectric between the electrodes 190 and 270. The pixel electrode 190 is connected to the switching element Q, and the common electrode 270 covers the entire surface of the upper panel 100 and is supplied with a common voltage V_{com}. Alternatively, both the pixel electrode 190 and the common electrode 270, which have shapes of bars or stripes, may be provided on the lower panel 100.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100. The separate signal line overlaps the pixel electrode 190, and the two are separated via an insulator. The signal line is supplied with a predetermined voltage such as the common voltage Vcom. Alternatively, the storage capacitor C_{ST} includes a pixel electrode 190 that overlaps an adjacent gate line (called a “previous gate line”), which is separated from the pixel electrode 190 via an insulator.

For a color display, each pixel uniquely represents one of three primary colors such as red, green, and blue colors (spatial division) or sequentially represents the three primary colors in time (temporal division). FIG. 2 shows an example of spatial division, where each pixel includes a color filter 230 representing one of the three primary colors in an area of the upper panel 200 facing the pixel electrode 190. Alternatively, the color filter 230 is provided on or under the pixel electrode 190 on the lower panel 100.

The backlight unit 900 includes a light source unit 910 that includes a plurality of lamps (not shown) provided at the lower side of the LC panel unit 300. For a small and medium sized LCD, light emitting diodes (LEDs) are used as the lamp, and the LCD may be an edge type in which the lamps are disposed at the edge of the lower side with a light guide plate.

A pair of polarizers (not shown) for polarizing the light from the light source unit 910 are attached on the outer surfaces of the lower and upper panels 100 and 200 of the panel unit 300.

Referring to FIG. 3A, an LCD according to an embodiment of the present invention includes two panel units of a main panel unit 300M and a subsidiary panel unit 300S, a main FPC 680M attached to the main panel unit 300M, a driving FPC 650 attached to the main FPC 680M, an auxiliary FPC 680S attached between the main and the subsidiary units 300M and 300S, and an integration chip 700 mounted on the main panel unit 300M.

The panel units 300M and 300S include display areas 310M and 310S forming screens, and peripheral areas 320M and 320S, respectively. The peripheral areas 320M and 320S may include light-blocking layers (not shown) (“black matrix”) for blocking light. Most of the pixels and the display signal lines G₁-Gₙ and D₁-Dₘ are disposed in the display areas 310M and 320M.

The main panel unit 300M and the subsidiary panel unit 300S are connected via the auxiliary FPC 680S, and the main FPC 680M is attached to the lower side of the main panel unit 300M and to the driving FPC 650, which is shown in FIG. 3B.

The driving FPC 650, which is also called an interface FPC, includes a connector 660 connected to an external device and is provided with signal lines (not shown) transmitting signals from the external device and pads (not shown), which are located at the ends of the signal lines. Additionally, the main and auxiliary FPC's 680M and 680S and the panel units 300M and 300S are also provided with pads.

The driving FPC 650 has an opening 690 exposing the subsidiary panel unit 300S in a folded state. The driving FPC 650 also has a driving circuitry unit 750 that controls currents applied to the light source unit 910 of the backlight unit 910.

Solder or anisotropic conductive film may be used to electrically connect the pads of the driving FPC 650 with the pads of the main and subsidiary FPCs 680M and 680S, and the pads of the panel units 300M and 300S.

Referring back to FIG. 1, a gray voltage generator 800 generates one set or two sets of gray voltages related to a transmittance of the pixels. When two sets of the gray voltages are generated, the gray voltages in one set have a positive polarity with respect to the common voltage V_{com}, while the gray voltages in the other set have a negative polarity with respect to the common voltage V_{com}.

The gate driver 400 is connected to the gate lines G₁-Gₙ of the panel unit 300 and synthesizes the gate-on voltage Vₒₙ and the gate-off voltage V_{off} from an external device to generate gate signals for application to the gate lines G₁-Gₙ.

The data driver 500 is connected to the data lines D₁-Dₘ of the panel unit 300 and applies data voltages, which are selected from the gray voltages supplied from the gray voltage generator 800, to the data lines D₁-Dₘ.

The signal controller 600 controls the gate driver 400 and the data driver 500.

The integrated circuit 700 is supplied with external signals via signal lines provided on the connector 660 and the driving FPC 650. The integrated circuit 700 supplies control signals to the main panel unit 300M and the subsidiary panel unit 300S via signal lines provided on the peripheral area 320M and the auxiliary FPC 680M. The integrated circuit 700 includes the signal controller 600, the gate driver 400, the data driver 500, and the gray voltage generator 800 shown in FIG. 1.

Now, the operation of the display device is described in detail referring to FIG. 1.

The signal controller 600 is supplied with image signals R, G, and B, as well as input control signals. The input control signals, which are received from an external graphic controller (not shown), include, for example, a vertical synchronization signal Vsync, a horizontal synchronization signal Hsync, a main clock MCLK, and a data enable signal DE. After generating gate control signals CONT1 and data control signals CONT2 and processing the image signals R, G, and B for the panel unit 300, in response to the input control signals, the signal controller 600 provides the gate control signals CONT1 to the gate driver 400, and the processed image signals DAT and the data control signals CONT2 to the data driver 500.

The gate control signals CONT1 include a vertical synchronization start signal STV for informing the gate driver of a start of a frame, a gate clock signal CPV for synchronizing the timing of the gate-on voltage Vₒₙ, and an output enable signal OE that controls the duration of the gate-on voltage Vₒₙ.

The data control signals CONT2 include a horizontal synchronization start signal STH for informing the data driver 500 of the start of a horizontal period, a load signal LOAD or TP for instructing the data driver 500 to apply the appropriate data voltages to the data lines D₁-Dₘ, and a data clock signal HCLK. The data control signals CONT2 may further include an inversion control signal RVS for reversing the polarity of the data voltages (with respect to the common voltage V_{com}).

The data driver 500 receives the processed image signals DAT for a pixel row from the signal controller 600, and converts the processed image signals DAT into analog data voltages in response to the data control signals CONT2 from the signal controller 600. The levels of the analog data voltages are selected from the gray voltages supplied from the gray voltage generator 800

In response to the gate control signals CONT1 from the signal controller 600, the gate driver 400 applies the gate-on voltage Von to the gate lines G₁-Gₙ, thereby turning on the switching elements Q connected to the gate lines G₁-Gₙ.

The data driver 500 applies the data voltages to corresponding data lines D₁-Dₘ for a duration of “one horizontal period” or “1 H.” This duration is equal to the duration of one periodic cycle of signals such as the horizontal synchronization signal Hsync, the data enable signal DE, and the gate clock signal CPV. The data voltages are then supplied to corresponding pixels via the turned-on switching elements Q.

The difference between the data voltage and the common voltage Vcom applied to a pixel is manifested as a charged voltage of the LC capacitor C_{LC}, i.e., a pixel voltage. The liquid crystal molecules have orientations depending on the magnitude of the pixel voltage, and those orientations determine the polarization of light passing through the LC capacitor C_{LC}. The polarizers convert light polarization into light transmittance.

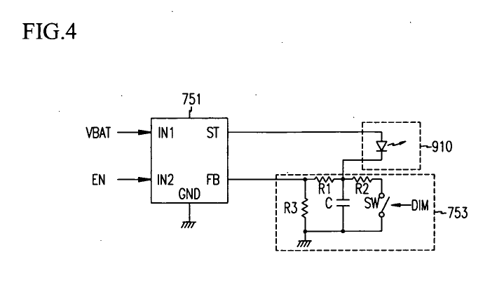

By repeating the above-described procedure for each gate line, all gate lines G₁-Gₙ are sequentially supplied with the gate-on voltage Vₒₙ during a frame, thereby applying the data voltages to all pixels. When one frame finishes and the next frame starts, the inversion control signal RVS is applied to the data driver 500 such that the polarity of the data voltages for the next frame will be reversed (“frame inversion”). Alternatively, the inversion control signal RVS may be controlled such that the polarity of the data voltages in one frame is reversed for every row (e.g.: “row inversion”). Or, the polarity of the data voltages may be reversed for every column (e.g.: “column inversion”). An LCD according to an embodiment of the present invention will now be described with reference to FIGS. 4-8.

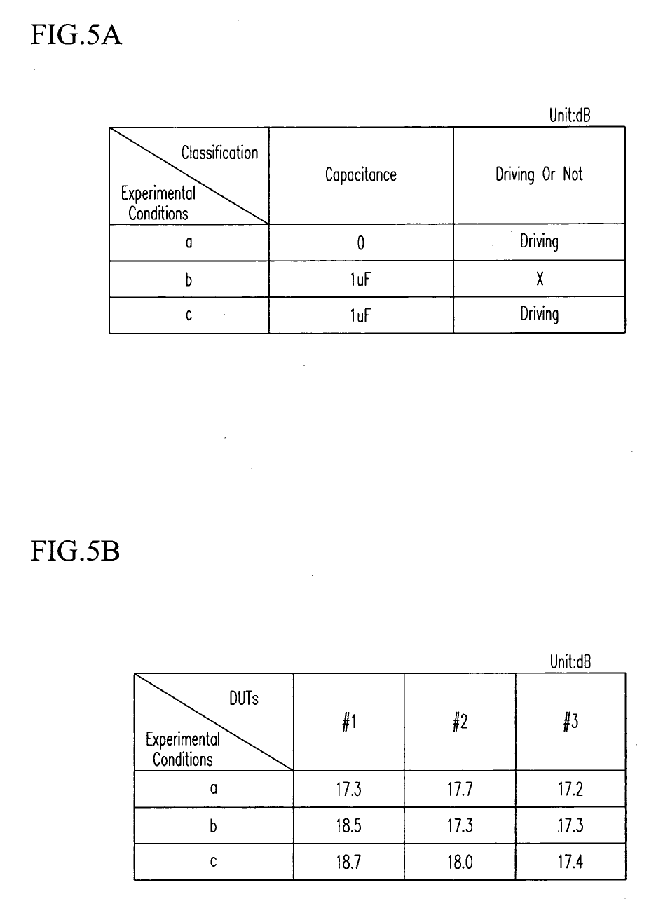

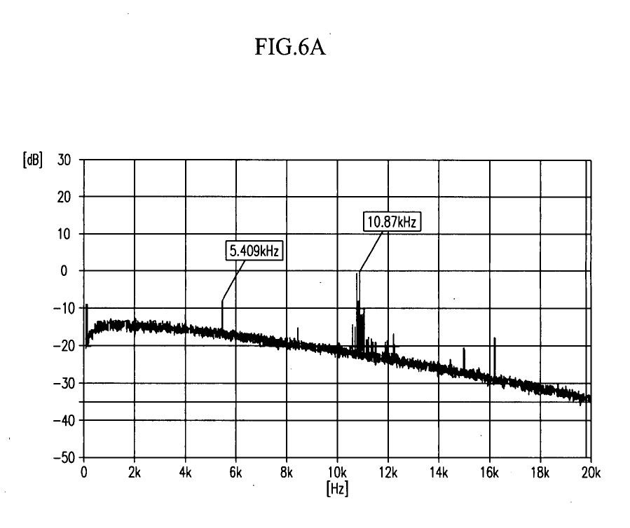

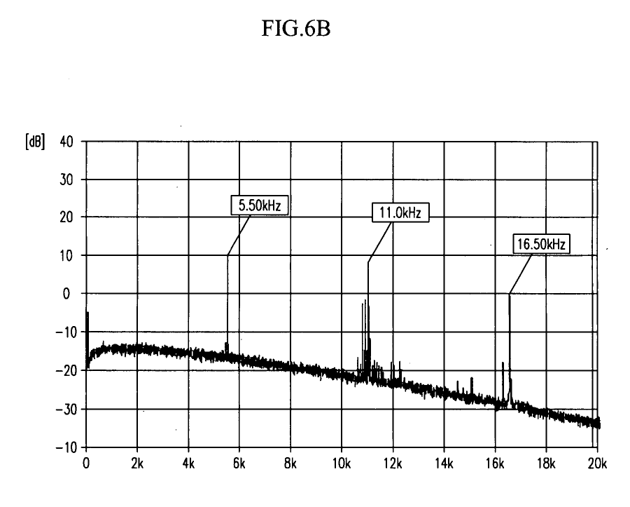

FIG. 4 is a schematic of the driving circuitry unit 750 in the driving FPC 650 shown in FIG. 3B. FIGS. 5A and 5B are tables illustrating experimental conditions under which noise levels of an LCD according to an embodiment of the present invention were measured. FIGS. 6A and 6B show how the noise levels depend on the capacitance of the capacitor shown in FIG. 4, for an LCD of the present invention.

FIG. 4 shows the driving circuitry unit 750 shown in FIG. 3B and the light source unit 910, which is an LED connected to the driving circuitry unit.

The driving circuitry unit 750 according to an embodiment of the present invention includes a current generator 751 and a current setting unit 753.

The current generator 751 includes an integrated circuit chip which includes five terminals, which are first and second input terminals IN1 and IN2, a switching terminal ST, a feedback terminal FB, and a ground terminal GND.

The first input terminal is supplied with a DC power supply voltage V_{BAT} required for driving the LCD, and the second input terminal is supplied with an enable signal En for operating the backlight unit 900. The current generator 751 outputs an alternating current (AC) to the LED 910 at a constant frequency via the switching terminal ST. The feedback terminal FB is supplied with a current that is fed back from the current setting unit 753. The current generator 751 senses the amount of current fed into the terminal FB, and adjusts the current supplied by the switching terminal ST to maintain a constant amount of current fed into the terminal FB. The ground terminal GND is connected to a ground voltage.

The current setting unit 753 includes a plurality of resistors R1-R3 and a switching element SW, and it controls operation of the switching element SW in response to a dimming signal DIM to adjust the amount of current flowing into the LED 910, thereby controlling the brightness of the LED 910. When the LED is dimmed, it is referred to as being in the ‘dimmed mode’ hereinafter. In this mode, the amount of the current flowing into the LED is gradually reduced and causes it to be darker.

In a preferred embodiment, the values of the resistors R1, R2, and R3 are 1 kilo-Ohm, 6.2 Ohms, and 33 Ohms, respectively. Note that other variations in these resistance values are possible, such as proportionally scaling the values by a constant. Such variations will be obvious to those skilled in the art of circuit design.

FIGS. 5A and 5B are tables showing the noise levels of three device-under-tests (DUTs) measured under three different sets of experimental conditions. A microphone is disposed above the DUT at a distance of 3 cm in a noise-free room and then the noise is measured.

The experimental conditions a, b, and c are characterized by two variables. First, the capacitance of the capacitor C in the current setting unit 753 is 0 Farads (i.e., no capacitor) under condition a, and 1 micro-Farad (or 1×10⁻⁶ Farads) under conditions b and c. Second, under conditions a and c, the LCD is driven, while under condition b, it is not. The driven condition corresponds to when a folded-type mobile phone is unfolded, whereas the not driven condition corresponds to when such a phone is folded.

Under each of these conditions, the total amount of noise generated over a fixed period of time was measured for each of three device-under-tests, and the results are displayed in FIG. 5B. The values are given in decibel ratios (dB) relative to a sound pressure of 20 uPa (micro Pascals), i.e., 20 log (amplitude of noise/20 uPa).

The noise is measured in the time domain, then converted into the frequency domain by a Fourier transform, giving more detailed information in a corresponding frequency. FIGS. 6A and 6B are graphs which show the measured noise for two conditions a and c in the DUT #1. Noise is also measured in the same manner in the remaining DUTs #2 and #3.

As noted from FIG. 5B, the noise level measured from DUT #1 under condition a is 17.3 dB, while that measured under condition c is 18.7 dB. Thus the noise level measured for a DUT with a capacitance of 1 uF is larger than that for a DUT with a capacitance of 0 uF by 1.4 dB. This difference may be explained by examining the spectral components shown in FIGS. 6A and 6B, which reveal a much higher noise spectral density around 5.409 to 5.5 kHz for condition c than for condition a. Likewise, for the DUTs #2 and #3, the noise generated when the capacitor C is removed is smaller.

Although experimental results in the capacitor-free state have been described, the same results may be achieved when the capacitance of the capacitor C is 100 nF or less.

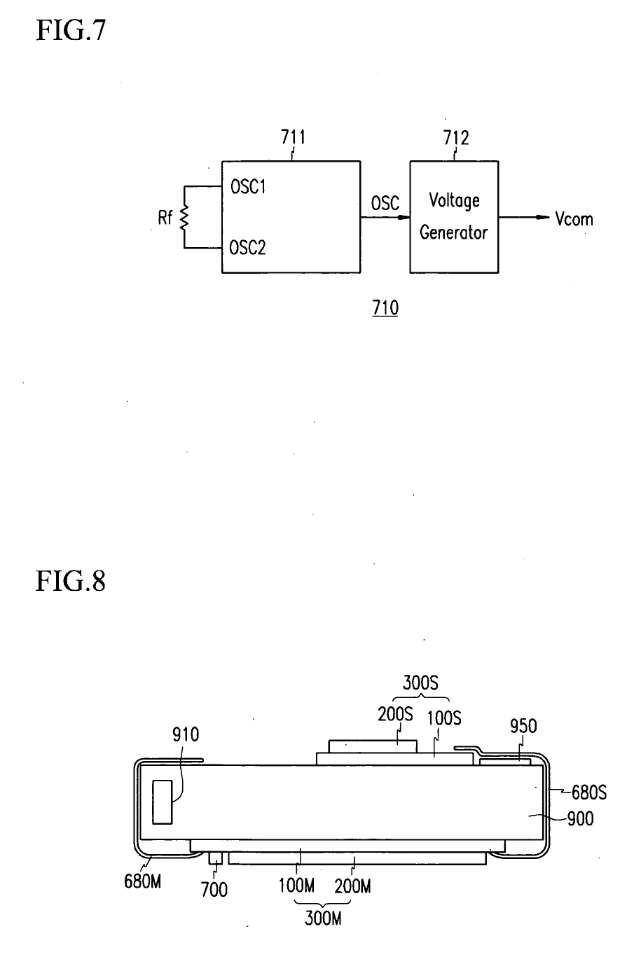

FIG. 7 is a block diagram of a common voltage generator according to another embodiment of the present invention.

A common voltage generator 710 according to an embodiment of the present invention includes an oscillator 711 and a voltage generator 712 connected thereto, and a resistor Rf is connected between two terminals OSC1 and OSC2 of the oscillator 711.

The oscillator 711 generates an oscillation signal OSC, and the voltage generator 712 adjusts a frequency of the common voltage V_{com} responsive to the oscillation signal OSC.

For driving a small and medium sized LCD with smaller data voltages relative to a large LCD, the common voltage Vcom is varied between a maximum voltage reference and a minimum voltage reference at a constant frequency, so as to increase the differential voltages at the pixel inputs. The frequency corresponds to a multiplication of a frame frequency by the number of gate lines. For example, for 60 frames a second when the number of gate lines is 160, the frequency is 9.6 kHz, which falls within the range of human audible frequencies.

Referring back to FIGS. 6A and 6B, the noise level rapidly increases at 10.87 kHz, as shown in FIG. 6A and rapidly increases at 11.0 kHz, as shown in FIG. 6B. This increase is deemed to be caused by the frequency of the common voltage V_{com}.

Thus, to reduce the audible noise, it would be preferable to increase the common voltage frequency to a frequency beyond the audible range. For example, the common voltage frequency could be designed to exceed 20 kHz. Adjustment of the common voltage frequency could be performed by adjusting a resistance of the resistor Rf connected to the oscillator 711. As the resistance of the resistor Rf is inversely proportional to the frequency, the resistance of the resistor Rf is reduced to increase the frequency of the common voltage beyond the audible frequency of 20 kHz.

FIG. 8 is a schematic lateral side view of an LCD according to another embodiment of the present invention, and it combines the LCD shown in FIG. 3A and the backlight unit 900.

The backlight unit 900 provides light for two panel units 300 M and 300S through the light source unit 910 disposed at the left with respect to FIG. 8 and a light guide plate (not shown). Two panel units 300M and 300S are disposed opposite to each other, with the backlight unit 910 interposed between the two panels.

The two panel units 300M and 300S include lower panels 100M and 100S and upper panels 200M and 200S, and the integration chip 700 is mounted on the lower panel 100M of the main panel unit 300M.

The main and the auxiliary FPCs 680M and 680S are folded and are attached to the surfaces of the backlight unit 900. The auxiliary FPC 680S is connected between the lower panel 100M of the main panel unit 300M and the lower panel 100S of the subsidiary panel unit 300S, and the main FPC 680M is connected to the driving FPC 650 (referring to FIG. 3B) in a folded state. The driving FPC 650 is disposed at the top of the backlight unit 900, and the subsidiary panel unit 300S is disposed in the opening 690 of the driving FPC 650.

In one embodiment of the invention, an insulating member 950, preferably made of a double sided tape, is interposed between the top of the backlight unit 900 and the subsidiary FPC 680S.

The insulating member 950 plays a part in blocking oscillation between the backlight unit 900 and the auxiliary FPC 680S to reduce noise. As described above, the integration chip 700 drives the main and subsidiary panel units 300M and 300S, the data voltages, the gate voltages, and the common voltage transmitted to the subsidiary panel unit 300S. These signals can combine with the alternating current from the current generator 751 described in FIG. 4 to generate noise. The insulating member 950 thus blocks the oscillation to reduce the noise.

While the present invention has been described in detail with reference to the preferred embodiments, the invention is not limited to the disclosed embodiments. On the contrary, the present invention covers various modifications and arrangements of the disclosed embodiments.

What is claimed is:

1. A liquid crystal display comprising:
a first panel unit;
a second panel unit;
a first flexible printed circuit film (FPC) having an opening exposing the second panel unit;
a light source unit including a plurality of lamps that provides light for the first and the second panel units; and
a current controller that controls a current applied to the light source unit and including a capacitor with a capacitance less than 100 nF.

2. The liquid crystal display of claim 1, wherein the current controller comprises:
a current generator including a plurality of terminals and connected to one end of the lamp; and
a current setting unit connected to the other end of the lamp and including the capacitor and a plurality of resistors.

3. The liquid crystal display of claim 2, wherein the current controller is located on the first FPC.

4. The liquid crystal display of claim 1, further comprising:
a second FPC attached to one side of the first panel unit; and
a third FPC attached between the other side of the first panel unit and one side of the second panel unit.

5. The liquid crystal display of claim 1, wherein the first and the second panel units comprise a plurality of pixels each including a switching element connected to first and second display signal lines.

6. The liquid crystal display of claim 5, further comprising:
a gate driver that generates gate signals for application to the first display signal lines; and
a data driver that generates data voltages for application to the second display signal lines.

7. The liquid crystal display of claim 6, further comprising a driving circuit chip that drives the first and the second panel units.

8. The liquid crystal display of claim 7, wherein the driving circuit chip comprises the gate driver and the data driver.

9. The liquid crystal display of claim 8, wherein the driving circuit chip is mounted on the first panel unit.

10. A liquid crystal display comprising:
a first panel unit;
a second panel unit;
a first flexible printed circuit film (FPC) having an opening exposing the second panel unit; and
a common voltage generator that generates a common voltage to be provided to the first and the second panel units,
wherein the frequency of the common voltage exceeds 20 kHz.

11. The liquid crystal display of claim 10, wherein the common voltage generator comprises:
an oscillator; and
a voltage generator that generates a voltage in response to a signal from the oscillator.

12. The liquid crystal display of claim 11, wherein the oscillator comprises a resistor connected between a first terminal and a second terminal, and having a resistance that is inversely proportional to the frequency of the common voltage.

13. The liquid crystal display of claim 10, further comprising:
a second FPC attached to one side of the first panel unit; and
a third FPC attached between the other side of the first panel unit and one side of the second panel unit.

14. The liquid crystal display of claim 10, wherein the first and the second panel units comprise a plurality of pixels each including a switching element connected to first and second display signal lines.

15. The liquid crystal display of claim 14, further comprising:
a gate driver that generates gate signals for application to the first display signal lines; and
a data driver that generates data voltages for application to the second display signal lines.

16. The liquid crystal display of claim 15, further comprising a driving circuit chip that drives the first and the second panel units.

17. The liquid crystal display of claim 16, wherein the driving circuit chip comprises the common voltage generator, the gate driver, and the data driver.

18. The liquid crystal display of claim 17, wherein the driving circuit chip is mounted on the first panel unit.

19. A liquid crystal display comprising:
a first panel unit;
a second panel unit;
a first flexible printed circuit film (FPC) having an opening exposing the second panel unit; and
a second FPC attached to one side of the first panel unit;
a third FPC attached between the other side of the first panel unit and one side of the second panel unit; and
a backlight unit providing light for the first and the second panel units,
wherein the first and the second panel units are disposed opposite to each other, the backlight unit is interposed between the first and second panel units, and an insulating member is provided between the third FPC and the side of the backlight unit facing the second panel unit.

20. The liquid crystal display of claim 19, wherein the insulating member is a double sided tape.

21. The liquid crystal display of claim 19, wherein the first and the second panel units comprise a plurality of pixels each including a switching element, and first and second display signal lines connected to each switching element.

22. The liquid crystal display of claim 21, further comprising:
a gate driver that generates gate signals for application to the first display signal lines; and
a data driver that generates data voltages for application to the second display signal lines.

23. The liquid crystal display of claim 22, further comprising a driving circuit chip that drives the first and the second panel units.

24. The liquid crystal display of claim 23, wherein the driving circuit chip comprises the gate driver and the data driver.

25. The liquid crystal display of claim 24, wherein the driving circuit chip is mounted on the first panel unit.

26. A current controller for controlling current applied to a light source unit in a liquid crystal display comprising:
a current generator connected to one end of a lamp in said light source unit;
a current setting unit connected to the other end of said lamp in said light source unit,
wherein said current setting unit comprises a capacitor with a capacitance of less than 100 nano-Farads.

27. The current controller of claim 26, wherein the current setting unit further comprises a plurality of resistors.

28. A common voltage generator for generating a common voltage to be applied to liquid crystal panels in a liquid crystal display wherein the voltage generator generates an alternating current (AC) voltage with a frequency greater than 20 kHz.

29. The common voltage generator of claim 28, wherein the voltage generator comprises:
an oscillator; and
a voltage generator generating a voltage in response to the output signal from the oscillator.

30. The common voltage generator of claim 29, wherein:
the oscillator comprises a resistor connected between a first terminal and a second terminal thereof; and
the resistance of the resistor is inversely proportional to the frequency of the common voltage.

31. A liquid crystal display comprising:
a first panel unit;
a second panel unit;
a first flexible printed circuit film (FPC) attached between one side of the first panel unit and one side of the second panel unit;
a backlight unit that provides light for the first and second panel units interposed between the first and second panel units; and
an insulating member interposed between the first FPC and the side of the backlight unit facing the second panel unit.

32. The liquid crystal display of claim 31, further comprising:
a second FPC having an opening exposing the second panel unit.

33. The liquid crystal display of claim 32, further comprising:
a third FPC attached to the side of the first panel unit opposite the side attached to the first FPC.
